(19) United States
(12) Patent Application Publication
(10) Pub. No.: US 2024/0218835 A1
(43) Pub. Date: Jul. 4, 2024

(54) OUTLET GUIDE VANES AND AN ACCESSORY DRIVE GEARBOX FOR A GAS TURBINE ENGINE

(71) Applicant: General Electric Company, Schenectady, NY (US)

(72) Inventors: Brandon W. Miller, Middletown, OH (US); John C. Schilling, Sharonville, OH (US)

(21) Appl. No.: 18/150,063

(22) Filed: Jan. 4, 2023

(51) Int. Cl. F02C 7/32; F01D 9/04

(52) U.S. Cl. CPC F02C 7/32; F01D 9/041; F05D 2220/36; F05D 2250/38; F05D 2260/4031

(57) ABSTRACT

Outlet guide vanes for a gas turbine engine are disclosed. An example apparatus includes fan blades surrounded by a fan case, outlet guide vanes positioned downstream from the fan blades, the outlet guide vanes having a first sloping angle in a direction of rotation of the fan blades and a second sloping angle in a direction of air flow through the fan case, and an accessory drive gearbox positioned at least partially on the fan case, the accessory drive gearbox positioned downstream from the outlet guide vanes, the accessory drive gearbox supported by the outlet guide vanes.

### FIELD OF THE DISCLOSURE

This disclosure relates generally to turbine engines and, more particularly, to outlet guide vanes for a gas turbine engine.

### BACKGROUND

A gas turbine engine generally includes, in serial flow order, an inlet section, a compressor section, a combustion section, a turbine section, and an exhaust section. In operation, air enters the inlet section and flows to the compressor section where one or more axial compressors progressively compress the air until it reaches the combustion section, thereby creating combustion gases. The combustion gases flow from the combustion section through a hot gas path defined within the turbine section and then exit the turbine section via the exhaust section.

In some configurations of gas turbine engines, a plurality of outlet guide vanes is positioned downstream from a fan. The outlet guide vanes are generally disposed between annular inner and outer walls and can direct airflow downstream from the fan. As such, outlet guide vanes are typically mechanically coupled to an engine casing.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of an example turbofan gas turbine engine in which examples disclosed herein may be implemented.

FIG. 2 is a perspective view of an example assembly constructed in accordance with teachings disclosed herein.

FIG. 3 is a diagram illustrating an axial view of example outlet guide vanes constructed in accordance with teachings disclosed herein.

FIG. 4 is another example diagram illustrating an axial view of example outlet guide vanes constructed in accordance with teachings disclosed herein.

FIG. 5 is another diagram illustrating one of the example outlet guide vanes in FIG. 4.

FIG. 6 is a side view of a portion of another example turbofan gas turbine engine constructed in accordance with teachings disclosed herein.

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “about” modifies its subjects/values to recognize the potential presence of variations that occur in real world applications. For example, “about” may modify dimensions that may not be exact due to manufacturing tolerances and/or other real world imperfections as will be understood by persons of ordinary skill in the art. For example, “about” may indicate such dimensions may be within a tolerance range of +/−10% unless otherwise specified in the below description.

### DETAILED DESCRIPTION

Aircrafts include engines that act as a propulsion system to generate mechanical power and forces such as thrust. A gas turbine, also called a combustion turbine or a turbine engine, is a type of internal combustion engine that can be implemented in the propulsion system of an aircraft. For example, a gas turbine can be implemented in connection with a turbofan or a turbojet aircraft engine. Gas turbines also have significant applications in areas such as industrial power generation.

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized. The following detailed description is therefore, provided to describe example implementations and not to be taken limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “first,” “second,” and the like, do not denote any order, quantity, or importance, but rather are used to distinguish one element from another. The terms “comprising,” “including,” and “having” are intended to be inclusive and mean that there may be additional elements other than the listed elements. As the terms “connected to,” “coupled to,” etc. are used herein, one object (e.g., a material, element, structure, member, etc.) can be connected to or coupled to another object regardless of whether the one object is directly connected or coupled to the other object or whether there are one or more intervening objects between the one object and the other object.

The terms “upstream” and “downstream” refer to the relative direction with respect to fluid flow in a fluid pathway. For example, “upstream” refers to the direction from which the fluid flows, and “downstream” refers to the direction to which the fluid flows.

As used herein, the terms “axial” and “longitudinal” both refer to a direction parallel to the centerline axis of a gas turbine (e.g., a turbofan, a core gas turbine engine, etc.), while “radial” refers to a direction perpendicular to the axial direction, and “tangential” or “circumferential” refers to a direction mutually perpendicular to the axial and radial directions. Accordingly, as used herein, “radially inward” refers to the radial direction from the outer circumference of the gas turbine towards the centerline axis of the gas turbine, and “radially outward” refers to the radial direction from the centerline axis of the gas turbine towards the outer circumference of gas turbine. As used herein, the terms “forward”, “fore”, and “front” refer to a location relatively upstream in an air flow passing through or around a component, and the terms “aft” and “rear” refer to a location relatively downstream in an air flow passing through or around a component.

The basic operation of a gas turbine implemented in connection with a turbofan engine of a propulsion system of an aircraft includes an intake of fresh atmospheric air flow through the front of the turbofan engine with a fan. In the operation of a turbofan engine, a first portion of the intake air bypasses a core gas turbine engine of the turbofan to produce thrust directly. A second portion of the intake air travels through a booster compressor (e.g., a first compressor) located between the fan and a high-pressure compressor (e.g., a second compressor) in the core gas turbine engine (e.g., the gas turbine). The booster compressor is used to raise or boost the pressure of the second portion of the intake air prior to the air flow entering the high-pressure compressor. The air flow can then travel through the high-pressure compressor that further pressurizes the air flow. The booster compressor and the high-pressure compressor each include a group of blades attached to a rotor and/or shaft. The blades spin at high speed relative to stationary vanes and each rotation of the blades subsequently compresses the air flow. The high-pressure compressor then feeds the pressurized air flow to a combustion chamber (e.g., combustor). In some examples, the high-pressure compressor feeds the pressurized air flow at speeds of hundreds of miles per hour. In some instances, the combustion chamber includes one or more rings of fuel injectors that inject a steady stream of fuel into the combustion chamber, where the fuel mixes with the pressurized air flow. A secondary use of the compressors, particularly the high-pressure compressor, is to bleed air for use in other systems of the aircraft (e.g., cabin pressure, heating, and air conditioning, etc.).

In the combustion chamber of the core gas turbine engine, the fuel is ignited with an electric spark provided by an igniter, where the fuel in some examples burns at temperatures of more than 2000 degrees Fahrenheit. The resulting combustion produces a high-temperature, high-pressure gas stream (e.g., hot combustion gas) that passes through another group of blades called a turbine. The turbine can include a low-pressure turbine and a high-pressure turbine, for example. Each of the low-pressure turbine and the high-pressure turbine includes an intricate array of alternating rotating blades and stationary airfoil-section blades (e.g., outlet guide vanes). The high-pressure turbine is located axially downstream from the combustor and axially upstream from the low-pressure turbine. As the hot combustion gas passes through the turbine, the hot combustion gas expands through the blades and/or vanes, causing the rotating blades coupled to rotors of the high-pressure turbine and the low-pressure turbine to spin.

The rotating blades of the high-pressure turbine and the low-pressure turbine serve at least two purposes. A first purpose of the rotating blades is to drive the fan, the high-pressure compressor, and/or the booster compressor to draw more pressured air into the combustion chamber. For example, in a dual-spool design of a turbofan, the low-pressure turbine (e.g., a first turbine) can be attached to and in force-transmitting connection with the booster compressor (e.g., the first compressor) and fan via a first shaft, collectively referred to as a first spool of the gas turbine, such that the rotation of a rotor of the low-pressure turbine drives a rotor of the booster compressor and the fan. For example, a high-pressure turbine (e.g., a second turbine) can be attached to and in force transmitting connection with the high-pressure compressor (e.g., a second compressor) via a second shaft coaxial with the first shaft, collectively referred to as a second spool of the gas turbine, such that the rotation of a rotor of the high-pressure turbine drives a rotor of the high-pressure compressor. A second purpose of the rotating blades is to spin a generator operatively coupled to the turbine section to produce electricity. For example, the turbine can generate electricity to be used by an aircraft, a power station, etc.

Examples disclosed herein utilize tangentially leaned (e.g., tilted) outlet guide vanes to strengthen (e.g., stiffen) the connection between inner and outer turbine frames. In other examples disclosed herein, outlet guide vanes are tangentially and axially leaned. Examples disclosed herein utilize tilted outlet guide vanes to limit the circumferential deflection in the inside of the engine (e.g., the core, the inner frame of the engine, etc.) and the outside of the engine (e.g., the outer frame of the engine, the fan case, etc.). Examples disclosed herein mitigate the risk of bending outlet guide vanes during operation of the gas turbine engine. Further, examples disclosed herein can increase the distance (e.g., spacing) between fan blades and outlet guide vanes, thereby reducing the noise (e.g., acoustic noise) output of the engine. Examples disclosed herein enable an accessory drive gearbox to be positioned on (e.g., including partially on or entirely on) the fan case. In particular, examples disclosed herein utilize tilted outlet guide vanes to enforce the connection between the inner and outer turbine frames such that a radial drive shaft can mechanically couple to an accessory drive gearbox positioned on the fan case with little to no angular deflection of the radial drive shaft. As such, examples disclosed herein enable a radial drive shaft to extend from a turbine shaft in the core of the engine to an accessory drive gearbox positioned on the fan case.

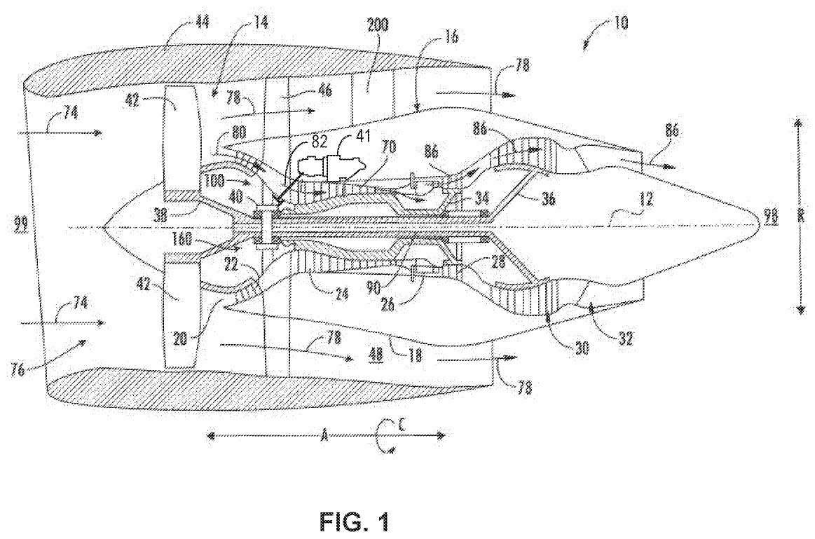

FIG. 1 is a cross-sectional view of a turbofan gas turbine engine in which examples disclosed herein may be implemented. Referring now to the drawings, FIG. 1 is a schematic partially cross-sectioned side view of an exemplary gas turbine engine 10 as may incorporate various examples of the present disclosure. The engine 10 may particularly be configured as a gas turbine engine for an aircraft. Although further described herein as a turbofan engine, the engine 10 may define a turboshaft, turboprop, or turbojet gas turbine engine, including marine and industrial engines and auxiliary power units. As shown in FIG. 1, the engine 10 has a longitudinal or axial centerline axis 12 that extends therethrough for reference purposes. An axial direction A is extended co-directional to the axial centerline axis 12 for reference. The engine 10 further defines an upstream end 99 and a downstream end 98 for reference. In general, the engine 10 may include a fan assembly 14 and a core engine 16 disposed downstream from the fan assembly 14. For reference, the engine 10 defines an axial direction A, a radial direction R, and a circumferential direction C. In general, the axial direction A extends parallel to the axial centerline axis 12, the radial direction R extends outward from and inward to the axial centerline axis 12 in a direction orthogonal to the axial direction A, and the circumferential direction extends three hundred sixty degrees (360°) around the axial centerline axis 12.

The core engine 16 may generally include a substantially tubular outer casing 18 that defines an annular inlet 20. The outer casing 18 encases or at least partially forms, in serial flow relationship, a compressor section having a booster or low pressure (LP) compressor 22, a high pressure (HP) compressor 24, a heat addition system 26, an expansion section or turbine section including a high pressure (HP) turbine 28, a low pressure (LP) turbine 30 and a jet exhaust nozzle section 32. A high pressure (HP) rotor shaft 34 drivingly connects the HP turbine 28 to the HP compressor 24. A low pressure (LP) rotor shaft 36 drivingly connects the LP turbine 30 to the LP compressor 22. The LP rotor shaft 36 may also be connected to a fan shaft 38 of the fan assembly 14. In certain examples, as shown in FIG. 1, the LP rotor shaft 36 is connected to the fan shaft 38 via a reduction gear 40 such as in an indirect-drive or geared-drive configuration. Additionally, as shown in FIG. 1, the reduction gear 40 is operatively connected to an accessory drive gearbox 41 positioned on the core engine 16.

As shown in FIG. 1, the fan assembly 14 includes a plurality of fan blades 42 that are coupled to and that extend radially outwardly from the fan shaft 38. An annular fan casing or nacelle 44 circumferentially may surround the fan assembly 14 and/or at least a portion of the core engine 16. It should be appreciated by those of ordinary skill in the art that the nacelle 44 may be configured to be supported relative to the core engine 16 by a plurality of circumferentially spaced struts or outlet guide vanes (OGVs) 46. In the example of FIG. 1, the leading and trailing edges of the OGVs extend radially outward from the core engine 16. The OGVs can be tangentially leaned with respect to the core engine 16. For example, the OGVs can be tangentially leaned but not axially leaned. In some examples, the outlet guide vanes 46 are static aerodynamic structures that can resist load due to the rotation of the fan blades 42 and/or the fan shaft 38. Moreover, at least a portion of the nacelle 44 may extend over an outer portion of the core engine 16 so as to define a fan flow passage 48 (e.g., flowpath) therebetween.

It should be appreciated that combinations of the shafts 34, 36, the compressors 22, 24, and the turbines 28, 30 define a rotor assembly 90 of the engine 10. For example, the HP rotor shaft 34, HP compressor 24, and HP turbine 28 may define a high speed or HP rotor assembly of the engine 10. Similarly, combinations of the LP rotor shaft 36, LP compressor 22, and LP turbine 30 may define a low speed or LP rotor assembly of the engine 10. Various examples of the engine 10 may further include the fan shaft 38 and fan blades 42 as the LP rotor assembly. In certain examples, the engine 10 may further define a fan rotor assembly that is at least partially mechanically de-coupled from the LP spool via the fan shaft 38 and the reduction gear 40. Still further examples may further define one or more intermediate rotor assemblies (not shown) defined by an intermediate pressure compressor, an intermediate pressure shaft, and an intermediate pressure turbine disposed between the LP rotor assembly and the HP rotor assembly (relative to serial aerodynamic flow arrangement).

During operation of the engine 10, a flow of air, shown schematically by arrows 74, enters an inlet 76 of the engine 10 defined by the fan case or nacelle 44. A portion of air, shown schematically by arrow 80, enters the core engine 16 through the annular inlet 20 defined at least partially via the outer casing 18. The flow of air is provided in serial flow through the compressors 22, 24, the heat addition system 26, and the expansion section via a core flow path 70. The flow of air 80 is increasingly compressed as it flows across successive stages of the compressors 22, 24, such as shown schematically by arrows 82. The compressed air 82 enters the heat addition system 26 and mixes with a liquid and/or gaseous fuel and is ignited to produce combustion gases 86. It should be appreciated that the heat addition system 26 may form any appropriate system for generating combustion gases, including, but not limited to, deflagrative or detonative combustion systems, or combinations thereof. The heat addition system 26 may include annular, can, can-annular, trapped vortex, involute or scroll, rich burn, lean burn, rotating detonation, or pulse detonation configurations, or combinations thereof.

The combustion gases 86 release energy to drive rotation of the HP rotor assembly and the LP rotor assembly before exhausting from the jet exhaust nozzle section 32. The release of energy from the combustion gases 86 further drives rotation of the fan assembly 14, including the fan blades 42. A portion of the air 74 bypasses the core engine 16 and flows across the fan flow passage 48, such as shown schematically by arrows 78.

It should be appreciated that FIG. 1 depicts and describes a two-stream engine having the fan flow passage 48 and the core flow path 70. The example depicted in FIG. 1 has a nacelle 44 surrounding the fan blades 42, such as to provide noise attenuation, blade-out protection, and other benefits known for nacelles, and which may be referred to herein as a “ducted fan,” or the entire engine 10 may be referred to as a “ducted engine.” In other examples, the engine 10 may be referred to herein as a “high bypass turbofan engine”. A high bypass turbofan engine includes a high bypass geared fan that allows a turbofan engine to drive more air (e.g., produce more thrust) for less air going through the core. In some examples, a high bypass turbofan engine burns less fuel than a ducted engine.

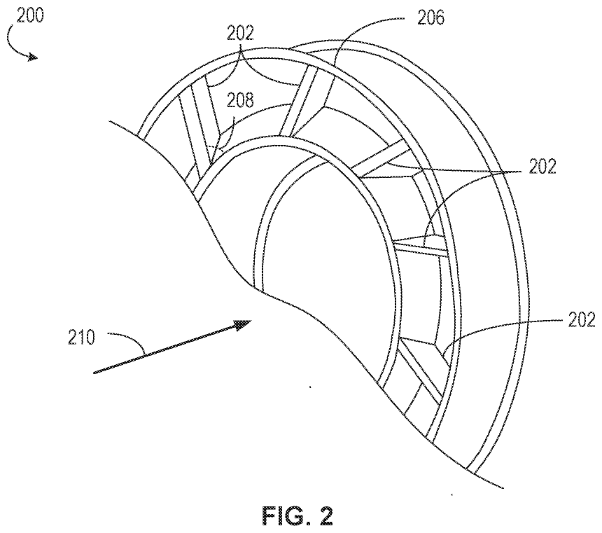

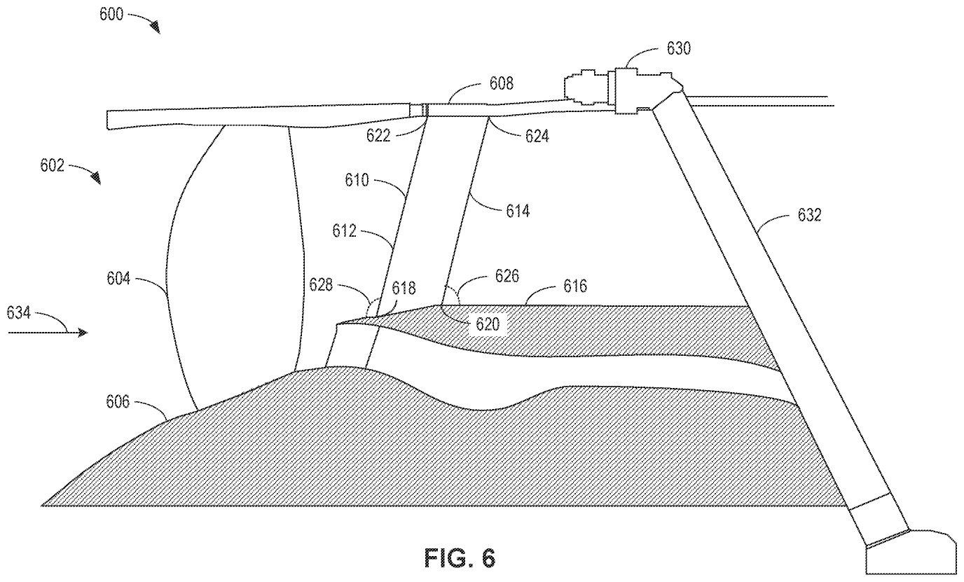

FIG. 2 is a perspective view of an example assembly 200 constructed in accordance with teachings disclosed herein. The example assembly 200 includes circumferentially spaced outlet guide vanes 202 positioned between an inner turbine frame 204 and an outer turbine frame 206 (e.g., the nacelle 44). As shown in FIG. 2, the example outlet guide vanes 202 are tangentially leaned to an angle 208. In some examples, each of the angles 208 are substantially equal (e.g., within 2 degrees). In other examples, each of the angles 208 are different (e.g., a first one of the angles 208 is about 15 degrees and a second one of the angles 208 is about 9 degrees). In some examples, each of the angles 208 differentiate within a range of 1 degree to 15 degrees. In some examples, the assembly 200 includes an accessory drive gearbox positioned on the outer turbine frame 206, as described in detail in connection with FIG. 6. In the example of FIG. 2, airflow through the example outlet guide vanes 202 is generally indicated by arrow 210.

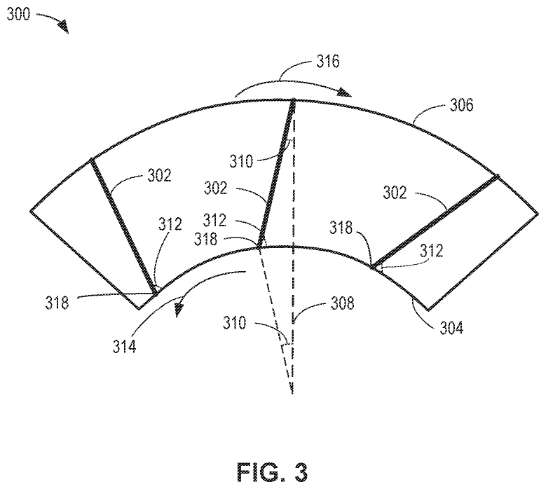

FIG. 3 is a diagram 300 illustrating an axial view of example outlet guide vanes 302 constructed in accordance with teachings disclosed herein. The example outlet guide vanes 302 are arranged circumferentially between an inner turbine frame 304 and an outer turbine frame 306, wherein the inner turbine frame 304 is aligned to (e.g., concentric with) the outer turbine frame 306. As shown in FIG. 3, an example axis 308 extends radially from a central point of the inner turbine frame 304 to a point on the outer turbine frame 306. In some examples, the tangential lean of the outlet guide vanes 302 is defined by an angle measured from the axis 308. For example, the outlet guide vanes 302 are positioned at an angle 310 from the axis 308. In some examples, the angle 310 is about 15 degrees (e.g., in a range from 1 degree to 15 degrees). In other examples, the outlet guide vanes 302 can be positioned at an angle 312 relative to the inner turbine frame 304.

Although the inner turbine frame 304 and the outer turbine frame 306 are intended to be stationary parts, during operation the rotation of the fan can cause the inner turbine frame 304 to move relative to the outer turbine frame 306. This is sometimes known as a windup or relative tangential rotational displacement. In the example of FIG. 3, the inner turbine frame 304 has rotational displacement (e.g., moves) counterclockwise, as generally indicated by arrow 314, and the outer turbine frame 306 has rotational displacement clockwise, as generally indicated by arrow 316. The outlet guide vanes 302 counteract the displacement motion (e.g., rotations, forces, etc.) of the inner turbine frame 304 and outer turbine frame 306. In other words, the outlet guide vanes 302 are static structures in tension during operation. Thus, the outlet guide vanes 302 can be subject to angular deflection in operation. For example, angular deflection can occur at example connection points 318 between ones of the outlet guide vanes 302 and the inner turbine frame 304. The outlet guide vanes 302 can better counteract the displacement motion of the turbine frames 304, 306 because the tangential lean enables the forces to distribute throughout the turbine frames 304, 306. If, for example, the outlet guide vanes 302 were not tangentially leaned, then the displacement forces would be concentrated at the connection points 318, increasing the risk of a failure mode at the connection points 318. This force distribution due to the tangential lean of the outlet guide vanes 302 enables additional components (e.g., an accessory drive gearbox, a radial drive shaft, etc.) to be added or moved within an example engine (e.g., the engine 10).

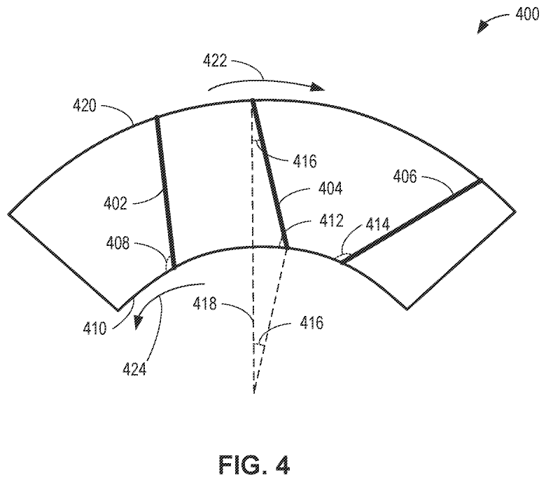

FIG. 4 is another example diagram 400 illustrating an axial view of example outlet guide vanes 402, 404, 406 constructed in accordance with teachings disclosed herein. The example diagram 400 of 4IG. 5 is similar to the example diagram 300 of FIG. 3, but, instead, the example outlet guide vanes 402, 404, 406 are tangentially leaned in different directions and at different angles. For example, the outlet guide vane 402 is positioned at an angle 408 relative to an inner turbine frame 410, the outlet guide vane 404 is positioned at an angle 412 relative to the inner turbine frame 410, and the outlet guide vane 406 is positioned at an angle 414 relative to the inner turbine frame 410. In some examples, the outlet guide vane 404 can be positioned at an angle 416 relative to an axis 418 extending from a central point of the inner turbine frame 410 to a point on an outer turbine frame 420. Further, the outlet guide vanes 402, 406, are angled along the clockwise direction as generally indicated by arrow 422. Alternatively, the outlet guide vane 404 is angled along the counterclockwise direction as generally indicated by arrow 424. In some examples, the outlet guide vane 404 that is angled in a direction different from the outlet guide vanes 402, 406 enable different orientations of the diagram 400 depending on spacing within the turbine frames 410, 420 or force distribution requirements between the turbine frames 410, 420.

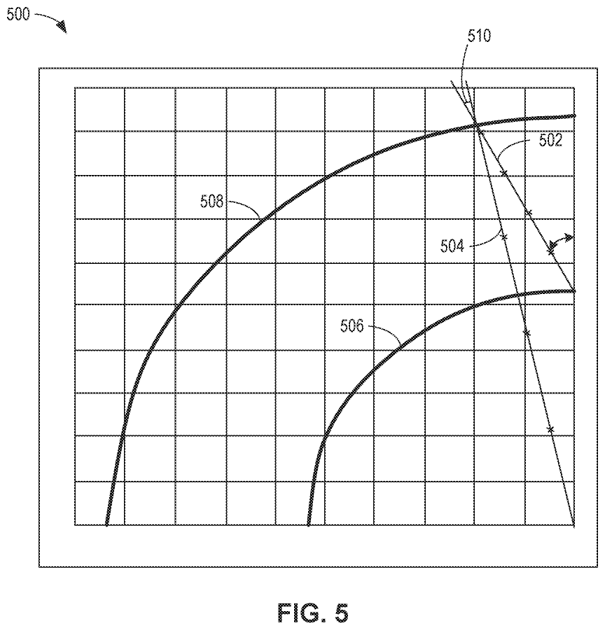

FIG. 5 is another example diagram 500 to illustrate another axial view of an example outlet guide vane 502 In some examples, the tangential lean of the outlet guide vane 502 can be determined by an axis 504 and a theoretical extension of the outlet guide vane 502 beyond an inner turbine frame 506 and the outer turbine frame 508. In particular, an angle 510 is defined as the angle between the axis 504 and the theoretical extension of the outlet guide vane 502. In some examples, the angle 510 can be referred to as a tilt angle.

As previously mentioned, the rotation of the fan during operation can cause the inner turbine frame 506 (e.g., the inner turbine frame 204, the inner turbine frame 304, the inner turbine frame 410, etc.) to displace or otherwise move relative to the outer turbine frame 508 (e.g., the outer turbine frame 206, the outer turbine frame 306, the outer turbine frame 420, etc.). In the example of FIG. 5, the inner turbine frame 506 rotates counterclockwise and the outer turbine frame 508 rotates clockwise. The outlet guide vane 502 counteracts the motion of the turbine frames 506, 508. Thus, the outlet guide vanes 502 can be subject to angular deflection in operation.

FIG. 6 is a side view of a portion of another example turbofan gas turbine engine 600 constructed in accordance with teachings disclosed herein. The example turbofan gas turbine engine 600 includes a fan assembly 602 including a fan blade 604 that is coupled to and extends radially outward from a fan shaft 606. An example annular fan case 608 circumferentially surrounds (e.g., encloses) the fan assembly 602 as well as an outlet guide vane 610. The example outlet guide vane 610 is positioned downstream from the fan assembly 602. The example outlet guide vane 610 is a stationary structure, whereas the fan blade 604 and the fan shaft 606 are rotatable structures. For purposes of explanation, FIG. 6 illustrates one fan blade and one outlet guide vane. However, a gas turbine engine (e.g., the turbofan gas turbine engine 600) can include any suitable number of fan blades and any suitable number of outlet guide vanes. The example outlet guide vane 610 includes a leading edge 612 and a trailing edge 614.

As shown in FIG. 6, the example outlet guide vane 610 is mounted to and extends radially between an inner turbine frame 616 (e.g., hub, core cowl, inner turbine frame, a surface of the inner turbine frame 616, etc.) and the fan case 608 (e.g., a surface of the fan case 608, etc.) of the turbofan gas turbine engine 600. The example fan case 608 circumferentially encloses (e.g., at least partially circumferentially encloses) the example inner turbine frame 616. As such, the example outlet guide vane 610 includes first ends 618, 620 attached to the inner turbine frame 616 and second ends 622, 624 attached to the fan case 608.

The example outlet guide vane 610 is axially leaned along the direction of airflow. For example, the outlet guide vane 610 includes a sloping angle 626 (e.g., in the axial direction) between the trailing edge 614 and the inner turbine frame 616. In other examples, the outlet guide vane 610 can be axially leaned to a sloping angle 628 between the leading edge 612 and the inner turbine frame 616. Accordingly, the second end 622 is downstream from the first end 618 and the second end 624 is downstream from the first end 620. In some examples, the axial lean of the outlet guide vane 610 can be measured from a surface of the fan case 608.

The example turbofan gas turbine engine 600 includes an accessory drive gearbox 630 positioned on the fan case 608. In some examples, the accessory drive gearbox 630 is partially positioned on the fan case 608. The example accessory drive gearbox 630 is operationally coupled to an example radial drive shaft 632. As shown in FIG. 6, the example radial drive shaft 632 extends radially from an interior portion of the turbofan gas turbine engine 600. In some examples, the radial drive shaft 632 is driven by a turbine shaft of the gas turbine engine, a low pressure compressor shaft, or a high pressure compressor shaft. Further, the accessory drive gearbox 630 can utilize power from the turbine shaft to power components such as generators and hydraulic pumps of the airplane.

During operation, the fan assembly 602 compresses air entering the turbofan gas turbine engine 600 through an inlet in an axial direction, as generally indicated by arrow 634. The airflow exiting the fan assembly 602 flows past and interacts with the outlet guide vane 610 (e.g., multiple ones of the outlet guide vane 610) such that the airflow can be straightened. In other words, the example outlet guide vane 610 redirects the airflow to an axial flow direction. Moreover, the example outlet guide vane 610 can resist sheer loads that occur due to the rotation of the fan blades, maneuver loads of the aircraft, and/or mitigate a failure of one of the fan blades. As such, the example outlet guide vane 610 is an aerodynamic structural feature of the example turbofan gas turbine engine 600.

In some prior implementation examples, outlet guide vanes are positioned perpendicular to an inner turbine frame (e.g., not tangentially leaned). In such examples, the angular deflection of the outlet guide vanes during operation can result in failure of the outlet guide vane and turbine frame assembly. A failure can occur when any of the outlet guide vanes bend as the shear stresses from the rotating turbine frames pull the vanes in opposing directions. Another example failure can occur at connection points between the outlet guide vanes and the turbine frame. For example, when the load at a connection point exceeds a maximum load, the outlet guide vane can break (e.g., fracture, disconnect, etc.) from the turbine frame. Typically, prior implementation examples of perpendicular outlet guide vanes operate at a maximum load capacity such that little to no additional load can be placed on the turbine frame without resulting in a failure.

In the examples of FIGS. 2-6, the outlet guide vanes 202, 302, 402, 404, 406, 502, 610 can mitigate the failure modes of prior implementation examples and can operate at a load capacity that enables additional components to attach to the turbine frame. In particular, the tangential leans of the outlet guide vanes 202, 302, 402, 404, 406, 502, position (e.g., angle) the outlet guide vanes 202, 302, 402, 404, 406, 502, to counteract the rotations of the turbine frames 204, 206, 304, 306, 410, 420, 506, 508. In the example of FIG. 3, the outlet guide vanes 302 can distribute (e.g., separate, dissipate, etc.) the force acting on the example connection points 318 between the turbine frame 304 and ones of the outlet guide vanes 302 during operation. In some examples, this distribution of force can be referred to as the x and y components of a force vector. In the prior implementation example, the rotational force of the inner turbine frame acts on the connection point (e.g., at the perpendicular angle) between the outlet guide vane and the inner turbine frame, which is subject to failure under high loads. By contrast, the example outlet guide vanes 302 of FIG. 3 leaned to the angle 310 or the angle 312 enable the rotational force of the turbine frames 304, 306 to be distributed along the ones of the outlet guide vanes 302 and the inner turbine frame 304. Thus, the example of FIG. 3 illustrates that the outlet guide vanes 302 can operate with a higher load capacity than that of the prior implementation example. In turn, the example outlet guide vanes 302 can mitigate the aforementioned failure modes of the prior implementation example. Similarly, the outlet guide vanes 202 (FIG. 2), 402 (FIG. 4), 404 (FIG. 4), 406 (FIG. 4), 502 (FIG. 5) can mitigate the aforementioned failure modes of the prior implementation example. Additionally or alternatively, the axial lean of the outlet guide vane 610 enable the rotational force of the inner turbine frame 616 and the fan case 608 to be distributed along multiple ones of the outlet guide vane 610 and the inner turbine frame 616. Thus, the example of FIG. 6 illustrates that multiple ones the outlet guide vane 610 can operate with a higher load capacity than that of the prior implementation example. In turn, the multiple ones of the example outlet guide vanes 610 can mitigate the aforementioned failure modes of the prior implementation example.

The higher load capacity of the examples in FIGS. 2-6 enable additional components to be positioned on any of the outer turbine frames 206, 306, 420, 508 or the fan case 608. For example, the accessory drive gearbox 630 can be positioned on any of the example outer turbine frames 206, 306, 420, 508, or the fan case 608 such that the radial drive shaft 632 extending therethrough is subject to little or no angular deflection. In the prior implementation example, a radial drive shaft extending to the outer turbine frame could bend or break resulting in a failure of the engine. Thus, the tangential lean of the outlet guide vanes 202, 302, 402, 404, 406, 502 or the axial lean of the outlet guide vane 610 can reduce the angular deflection between the outlet guide vanes 202, 302, 402, 404, 406, 502 and the outer turbine frames 206, 306, 420, 508, or the fan case 608 to support the accessory drive gearbox 630. Additionally, the accessory drive gearbox 630 can be attached to and driven (e.g., powered) by the radial drive shaft 632 extending therefrom.

In some examples, the example assembly 200 of FIG. 2, the example diagram 300 of FIG. 3, the example diagram 400 of FIG. 4, the example diagram 500 of FIG. 5, and the example turbofan gas turbine engine 600 of FIG. 6 include first means for surrounding the gas turbine engine. For example, the first means for surrounding may be implemented by the example inner turbine frames 204, 304, 410, 506, 616.

In some examples, the example assembly 200 of FIG. 2, the example diagram 300 of FIG. 3, the example diagram 400 of FIG. 4, the example diagram 500 of FIG. 5, and the example turbofan gas turbine engine 600 of FIG. 6 include second means for surrounding the gas turbine engine. For example, the second means for surrounding may be implemented by the example fan case 608 or the example outer turbine frames 206, 306, 420, 508.

In some examples, the example assembly 200 of FIG. 2, the example diagram 300 of FIG. 3, the example diagram 400 of FIG. 4, the example diagram 500 of FIG. 5, and the example turbofan gas turbine engine 600 of FIG. 6 include means for straightening air flow. For example, the means for straightening air flow may be implemented by the example outlet guide vanes 202, 302, 402, 404, 406, 502, 610.

In some examples, the example assembly 200 of FIG. 2, the example diagram 300 of FIG. 3, the example diagram 400 of FIG. 4, the example diagram 500 of FIG. 5, and the example turbofan gas turbine engine 600 of FIG. 6 include means for transferring power. For example, the means for transferring power may be implemented by the example accessory drive gearbox 630.

From the foregoing, it will be appreciated that example systems, methods, apparatus, and articles of manufacture have been disclosed that utilize tilted outlet guide vanes to limit the circumferential deflection between in the inside of the engine and the outside of the engine. Examples disclosed herein tangentially and axially lean outlet guide vanes to strengthen the connection between inner and outer turbine frames. Examples disclosed herein mitigate the risk of bending outlet guide vanes during operation of the gas turbine engine. Further, examples disclosed herein can increase the distance between fan blades and outlet guide vanes, thereby reducing the noise output of the engine. Examples disclosed herein enable an accessory drive gearbox to be positioned on the fan case or an outer turbine frame. In particular, examples disclosed herein utilize tilted outlet guide vanes to enforce the connection between the inner and outer turbine frames such that a radial drive shaft can mechanically couple to an accessory drive gearbox positioned on the fan with little to no angular deflection of the radial drive shaft. As such, examples disclosed herein enable a radial drive shaft to extend from a turbine shaft in the core of the engine to an accessory drive gearbox positioned on the fan case or the outer frame.

Further aspects of the present disclosure are provided by the subject matter of the following clauses:

A gas turbine engine comprising fan blades surrounded by a fan case, outlet guide vanes positioned downstream from the fan blades, the outlet guide vanes having a first sloping angle in a direction of rotation of the fan blades and a second sloping angle in a direction of air flow through the fan case, and an accessory drive gearbox positioned at least partially on the fan case, the accessory drive gearbox positioned downstream from the outlet guide vanes, the accessory drive gearbox supported by the outlet guide vanes.

The gas turbine engine of any preceding clause, further including a radial drive shaft coupled to the accessory drive gearbox, the radial drive shaft extending from an interior portion of the gas turbine engine to the accessory drive gearbox.

The gas turbine engine of any preceding clause, wherein the first sloping angle is in a range between 1 degree and 15 degrees.

The gas turbine engine of any preceding clause, wherein the first sloping angle is measured from a surface of an inner turbine frame.

The gas turbine engine of any preceding clause, wherein the second sloping angle is measured from a surface of the fan case.

The gas turbine engine of any preceding clause, wherein the second sloping angle is measured from an axis, the axis extending radially from a center point of an inner turbine frame to a surface of the fan case.

The gas turbine engine of any preceding clause, wherein a first one of the outlet guide vanes is positioned at the first sloping angle and a second one of the outlet guide vanes is positioned at a third sloping angle in a direction of rotation of the fan blades, the first sloping angle different from the third sloping angle.

The gas turbine engine of any preceding clause, wherein the gas turbine engine is a high bypass turbofan engine.

The gas turbine engine of any preceding clause, wherein the outlet guide vanes include first ends and second ends, the second ends downstream from the first ends.

The gas turbine engine of any preceding clause, wherein the first ends are in contact with an inner turbine frame and the second ends are in contact with a surface of the fan case.

A turbine engine comprising an inner turbine frame and an outer turbine frame, the inner turbine frame defining a first flowpath along an axial direction and a bypass flowpath defined between the inner turbine frame and the outer turbine frame, a plurality of outlet guide vanes arranged circumferentially between the inner turbine frame and the outer turbine frame, at least one of the plurality of outlet guide vanes tangentially tilted relative to a surface of the inner turbine frame, and at least a portion of an accessory drive gearbox positioned on the outer turbine frame, a shaft of the accessory drive gearbox extending through the bypass flowpath.

The turbine engine of any preceding clause, wherein the at least the portion of the accessory drive gearbox is positioned downstream from the plurality of the outlet guide vanes.

The turbine engine of any preceding clause, when the turbine engine is operating, the inner turbine frame and the outer turbine frame include a first tangential rotational displacement and the at least one of the plurality of outlet guide vanes includes a second tangential rotational displacement, the first tangential rotational displacement less than the second tangential rotational displacement.

The turbine engine of any preceding clause, wherein the at least one of the plurality of outlet guide vanes is tangentially leaned with respect to an axis, the axis extending radially from a center point of the inner turbine frame to the outer turbine frame.

The turbine engine of any preceding clause, wherein the turbine engine is a high bypass turbofan engine.

The turbine engine of any preceding clause, wherein first ends of the plurality of the outlet guide vanes are in contact with the surface of the inner turbine frame and second ends of the plurality of the outlet guide vanes are in contact with a surface of the outer turbine frame.

The turbine engine of any preceding clause, wherein the second ends are positioned downstream from the first ends.

A turbine engine comprising a first means for surrounding the turbine engine and a second means for surrounding the turbine engine, the second means for surrounding to circumferentially enclose the first means for surrounding, the second means for surrounding aligned to the first means for surrounding, means for straightening air flow in the turbine engine extending radially from the first means for surrounding to the second means for surrounding, the means for straightening positioned at a first angle relative to an axial direction of the turbine engine and a second angle relative to a surface of the first means for surrounding, and means for transferring power positioned at least partially on the second means for surrounding, the means for transferring supported by the means for straightening.

The turbine engine of any preceding clause, wherein the means for transferring power is positioned downstream from the means for straightening air flow.

The turbine engine of any preceding clause, wherein the turbine engine is a high bypass turbofan engine.

The turbine engine of any preceding clause, wherein the second angle is measured from an axis, the axis extending radially from a center point of the first means for surrounding to the second means for surrounding.

The turbine engine of any preceding clause, wherein a first one of the means for straightening is positioned at the second angle and a second one of the means for straightening is positioned at a third angle, the second angle different from the third angle.

The turbine engine of any preceding clause, wherein the means for straightening include first ends and second ends, ones of the second ends downstream from ones of the first ends.

This written description uses examples to disclose the present disclosure, including the best mode, and also to enable any person skilled in the implementation to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. A gas turbine engine comprising:
fan blades surrounded by a fan case;
outlet guide vanes positioned downstream from the fan blades, the outlet guide vanes having a first sloping angle in a direction of rotation of the fan blades and a second sloping angle in a direction of air flow through the fan case; and
an accessory drive gearbox in contact with a surface of the fan case, the accessory drive gearbox positioned downstream from the outlet guide vanes, the accessory drive gearbox supported by the outlet guide vanes and the surface of the fan case.

2. The gas turbine engine of claim 1, further including a radial drive shaft coupled to the accessory drive gearbox, the radial drive shaft extending from an interior portion of the gas turbine engine to the accessory drive gearbox.

3. The gas turbine engine of claim 1, wherein the first sloping angle is in a range between 1 degree and 15 degrees.

4. The gas turbine engine of claim 1, wherein the first sloping angle is measured from a surface of an inner turbine frame.

5. The gas turbine engine of claim 1, wherein the second sloping angle is measured from the surface of the fan case.

6. The gas turbine engine of claim 1, wherein the surface of the fan case is a first surface of the fan case, wherein the second sloping angle is measured from an axis, the axis extending radially from a center point of an inner turbine frame to a second surface of the fan case.

7. The gas turbine engine of claim 1, wherein a first one of the outlet guide vanes is positioned at the first sloping angle and a second one of the outlet guide vanes is positioned at a third sloping angle in a direction of rotation of the fan blades, the first sloping angle different from the third sloping angle.

8. The gas turbine engine of claim 1, wherein the gas turbine engine is a high bypass turbofan engine.

9. The gas turbine engine of claim 1, wherein the outlet guide vanes include first ends and second ends, the second ends downstream from the first ends.

10. The gas turbine engine of claim 9, wherein the surface of the fan case is a first surface of the fan case, wherein the first ends are in contact with an inner turbine frame and the second ends are in contact with a second surface of the fan case.

11. A turbine engine comprising:
an inner turbine frame and an outer turbine frame, the inner turbine frame defining a first flowpath along an axial direction and a bypass flowpath defined between the inner turbine frame and the outer turbine frame;
a plurality of outlet guide vanes arranged circumferentially between the inner turbine frame and the outer turbine frame, at least one of the plurality of outlet guide vanes tangentially tilted relative to a first surface of the inner turbine frame; and
an accessory drive gearbox in contact with a second surface of the outer turbine frame, the accessory drive gearbox supported by the plurality of the outlet guide vanes and the second surface of the outer turbine frame, a shaft of the accessory drive gearbox extending through the bypass flowpath.

12. The turbine engine of claim 11, wherein the accessory drive gearbox is positioned downstream from the plurality of the outlet guide vanes.

13. The turbine engine of claim 11, when the turbine engine is operating, the inner turbine frame and the outer turbine frame include a first tangential rotational displacement and the at least one of the plurality of outlet guide vanes includes a second tangential rotational displacement, the first tangential rotational displacement less than the second tangential rotational displacement.

14. The turbine engine of claim 11, wherein the at least one of the plurality of outlet guide vanes is tangentially leaned with respect to an axis, the axis extending radially from a center point of the inner turbine frame to the outer turbine frame.

15. The turbine engine of claim 11, wherein the turbine engine is a high bypass turbofan engine.

16. The turbine engine of claim 11, wherein first ends of the plurality of the outlet guide vanes are in contact with the surface of the inner turbine frame and second ends of the plurality of the outlet guide vanes are in contact with the first surface of the outer turbine frame.

17. The turbine engine of claim 16, wherein the second ends are positioned downstream from the first ends.

18. A turbine engine comprising:
a first means for surrounding the turbine engine and a second means for surrounding the turbine engine, the second means for surrounding to circumferentially enclose the first means for surrounding, the second means for surrounding aligned to the first means for surrounding;
means for straightening air flow in the turbine engine extending radially from the first means for surrounding to the second means for surrounding, the means for straightening positioned at a first angle relative to an axial direction of the turbine engine and a second angle relative to a surface of the first means for surrounding; and
means for transferring power in contact with a surface of the second means for surrounding, the means for transferring supported by the means for straightening and the surface of the second means for surrounding.

19. The turbine engine of claim 18, wherein the means for transferring power is positioned downstream from the means for straightening air flow.

20. The turbine engine of claim 18, wherein the turbine engine is a high bypass turbofan engine.
